(19) United States
(12) Patent Application Publication
(10) Pub. No.: US 2009/0219601 A1
(43) Pub. Date: Sep. 3, 2009

(54) Multi-channel Chromatic Dispersion Compensator

(75) Inventors: Yossi Corem, Beit Shemesh (IL); Seong Woo Shu, Mount Olive, NJ (US); Gil Cohen, Livingston, NJ (US)

Correspondence Address: SALTAMAR INNOVATIONS, 30 FERN LANE, SOUTH PORTLAND, ME, 04106, US

(73) Assignee: XTELLUS, Morris Plains, NJ (US)

(21) Appl. No.: 11/911,047

(22) PCT Filed: Apr. 7, 2006
(86) PCT No.: PCT/IL06/00446

§ 371 Date: Apr. 30, 2008

(30) Foreign Application Priority Data
Apr. 7, 2006 (IL) PCT/IL2006/000446

(51) Int. Cl. G02F 1/03; G02F 1/13

(52) U.S. Cl. 359/279

(57) ABSTRACT

A multi-wavelength device to compensate for chromatic dispersion in an optical transmission by inducing a phase shift which varies quadratically as a function of the different frequencies within the transmission. The quadratic phase variation can be applied by dispersing the input optical signal such that different wavelength components are spatially spread, and disposing an array of phase shifting elements along the dispersion direction, such that different wavelengths pass through different phase shifting elements. The elements are actuated to provide a phase shift which varies at least partially quadratically along the dispersion axis, and thus generates at least a partially quadratic phase variation to the wavelength components. This compensates for a phase shift having a quadratic dependence on frequency, generated as a result of the chromatic dispersion. The device is tunable, such that changes in chromatic dispersion can be compensated for dynamically.

### FIELD OF THE INVENTION

The present invention relates to the field of chromatic dispersion compensation in optical communication systems, especially by introducing quadratically varying phase changes across the frequency band where the compensation is to be applied.

### BACKGROUND OF THE INVENTION

Dispersion compensation is commonly required in most fiber-optics-based communication systems. Chromatic dispersion (CD) leads to spreading of the light pulses that carry the binary bits of information. It results from the fact that the speed of light in the fiber is wavelength dependent, a phenomenon known as group velocity dispersion. Since the short light impulses necessarily contain a band of frequencies, and hence wavelengths, they spread temporally as they propagate along the fiber. The higher the bit-rate of the communication link, the greater its sensitivity to impairment by chromatic dispersion. For example, in a 10 Gb/s system using 100 picosecond pulses at a wavelength of 1.55 μm, after propagating about 80 Km. along standard communication fiber, the pulses will be broadened by chromatic dispersion to such an extent that successive binary pulses will have merged into each other. The information carried by the signal is then lost. Methods are available in the prior art for overcoming the harmful effects of CD.

The magnitude of the CD is determined by the fiber material, its structure and by the wavelength of light. In the example given above, the dispersion value is approximately 17 ps/nm/km., meaning that two pulses separated from each other by 1 nm in wavelength will be temporally separated by 17 ps after propagating 1 km along the fiber. In this wavelength range, the long wavelength pulses are the slower ones. One method of dispersion compensation is to install at the end of the communication link, a system that compensates for this difference of velocities, and equates the arrival time of all wavelengths at the end of the system. One simple embodiment is the use of a fiber in which the sign and slope of dispersion is opposite to that of the communication link—i.e. a fiber in which, for the above described example, the long wavelengths travel faster, such that the total system becomes dispersion free. Such dispersion compensating fibers (DCF) are widely used in modern optical communication systems. Since only the overall delay through the link is important, such compensators can be placed anywhere in the systems—at its input, its output or anywhere along it. Usually DCFs are placed in amplifier modules disposed along the length of the system link.

Such prior art DCFs are an adequate and convenient tool for dispersion compensation in single wavelength systems, but they are not suitable for Dense Wavelength Division Multiplexing (DWDM) systems. The main problem is that the chromatic dispersion changes somewhat from one wavelength channel to the next. A system can thus be designed with a DCF that eliminates the dispersion for a wavelength channel near the center of the DWDM transmission band, but the dispersion might then be incorrect at the long and short end of the DWDM span. This problem is usually referred to as the dispersion slope problem, since it results from the fact that the dispersion curve as a function of wavelength is not a straight line for normal fiber materials, and it is difficult to obtain a DCF with a matched dispersion slope exactly equal and opposite to that of the standard link fiber. One possible solution currently used is to separate the DWDM system into several bands and to correct each of them separately by its own DCF section. This trimming is usually done near the output end of the system, just before the receiver. It has the disadvantage that it requires the stocking of many components to achieve correct compensation.

A more significant problem arises in modern systems that involve add-and-drop ports and more complex architectures. In such systems, different channels may propagate over different length of fibers, and hence may require different dispersion compensation according to the switched route taken by the transmission. The prior art solutions using DCF's will then be totally ineffective. Moreover, since such networks are expected to be dynamic, the dispersion compensation module must also be capable of dynamic dispersion compensation. There is therefore an important need for a channelized dispersion compensation solution, in which each channel is individually and dynamically trimmable.

The disclosures of each of the publications mentioned in this section and in other sections of the specification, are hereby incorporated by reference, each in its entirety.

### SUMMARY OF THE INVENTION

The present invention seeks to provide a chromatic dispersion compensation device which can supply the desired level of compensation to different channels of an optical communication system, and in which the level of compensation can be dynamically varied across a desired band of frequencies.

Chromatic dispersion can be described mathematically in terms of the phase changes undergone by different frequency components of a signal as it traverses a system. If the phase shift acquired by a frequency component ω in traversing the system is defined as φ(ω), the transit time through the system is then given by the first derivative, dφ/dω, and the dispersion is the rate of change of this derivative, or d²φ/dω². Chromatic dispersion can therefore be described by a phase function which varies quadratically with frequency:

φ(ω)=½D(ω−ω₀)² (1)

where ω is the frequency of interest at which the dispersion is measured,

ω₀⁻ is the center frequency of the band of frequencies of interest, and

D is a dispersion parameter defining the magnitude of dispersion, expressed in (ps)²; the dispersion value of 17 ps/nm/km, as found in standard fibers at 1.55 μm, translates to approximately 20 ps².

In order to achieve effective dispersion compensation in a communication system, the device of the present invention imposes on signals traversing the system, a phase change preferably having a quadratic dependence on frequency, and which is of opposite sign to that generated in the system as a result of the chromatic dispersion, namely:

φ(ω)=−½D(ω−ω₀)² (2)

As explained above, such a device should preferably supply different levels of compensation to different channels. A practical solution in order to overcome the technical problem of supplying a wide and variable range of phase shifts, is to supply the major portion of the dispersion compensation by means of a fixed DCF, typically one which compensates for the dispersion near the center of the band of frequencies of interest, and then to add channelized dispersion compensation components at frequencies either side of this center-band frequency to take care of the residual dispersion not compensated for by the DCF. Such residual dispersion is usually less than 500 ps².

The phase shift function can preferably be generated by dispersing the channel or channels whose chromatic dispersion is to be compensated for, onto an array of phase shifting elements, by methods known in the art. A particularly convenient method of performing the phase shifting function is by use of an array of liquid crystal elements, wherein the quadratic function is generated by suitable biasing of neighboring pixels.

Practically, it may not be simple to generate a phase shift function having a pure quadratic dependence on the wavelength of the light passing therethrough, or, in terms of the preferred devices described in this application, a pure quadratic dependence on the spatial position of the dispersed light spots. However, in order to provide some measure of chromatic dispersion compensation over a limited wavelength range, an optical arrangement which generates a dependence of phase on wavelength or position which approximates a quadratic function may preferably be used, and such an arrangement is termed in this application, an approximate quadratic function, or a quasi-quadratic function, and may also be thuswise claimed. The closeness of the function to a pure quadratic function will determine the exactness with which the dispersion compensation can be achieved over the range selected. Conversely, the more distant the function from a pure second power relationship to wavelength or spot position, the less exact the dispersion compensation. Since any functional form can be analyzed into a polynomial series, which then includes a quadratic component, such an approximately quadratic function can alternatively and preferably be described as one having at least a partial quadratic variation of phase shift with wavelength.

One preferred method of providing an approximate quadratic phase function is by use of a single element phase shifter, instead of a complete array, whereby, in a liquid crystal implementation, the fall-off of the field either side of the single element generates a quasi-quadratic, or approximately quadratic functional dependence of phase shift on position. Use of such a single element phase shifter per channel enables a particularly simple preferred embodiment of the dispersion compensator of the present invention. In a communication system, the chromatic dispersion in each channel may preferably be corrected individually by application of the appropriate actuating voltage on the single element phase shifter of each channel. The level of correction of each channel can be changed dynamically to compensate for changing transmission conditions or routing conditions for the channel.

Where more accurate chromatic dispersion compensation is required, then the geometry of the phase shifting elements and the wavelength dispersive power of the device may preferably be arranged such that a number of elements cover the spot width of a single channel, such that a phase function closer to a pure quadratic function can be generated across the width of a single channel.

There is thus provided in accordance with a preferred embodiment of the present invention, an optical device comprising:

(i) an input port for receiving a multiwavelength optical signal,
(ii) a dispersive device for spatially separating different wavelength components of the multiwavelength optical signal along a dispersion direction, and
(iii) at least one phase shifting element disposed in the path of the separated wavelength components,
wherein the at least one phase shifting element is actuated such that it applies a phase shift having at least a partially quadratic variation with distance along the dispersion direction, to the different wavelength components of the multiwavelength optical signal. In such a device, the at least one phase shifting element may preferably be an array of phase shifting elements.

In accordance with a further preferred embodiment of the present invention, in any of the previously described devices, the phase shift has at least a partially quadratic variation as a function of wavelength of the optical signal. In such a case, the at least partially quadratic variation of phase shift as a function of wavelength of the optical signal is preferably operative to compensate for chromatic dispersion generated in the optical signal.

In any of the above-described devices the at least one phase shifting element is preferably actuated by means of an applied voltage.

There is even further provided in accordance with more preferred embodiments of the present invention, a device such as described above, and wherein at least one of the phase shifting elements is a liquid crystal element.

Furthermore, in any of the devices described above, the at least one phase shifting element can be varied. According to such embodiments, this variability preferably enables dynamic compensation of chromatic dispersion generated in an optical communication system.

Additionally, in accordance with still another preferred embodiment of the present invention, in any of the above described devices using an array of phase shifting elements, when the multiwavelength optical signal comprises a number of channels equally spaced in frequency from each other, the array of phase shifting elements may preferably be disposed such that successive channels of the multiwavelength optical signal fall on successive elements of the array. Alternatively and preferably, the array of phase shifting elements may be disposed such that at least one of the channels of the multiwavelength optical signal falls on successive elements of the array.

In accordance with a further preferred embodiment of the present invention, there is also provided a method of compensating for chromatic dispersion in a multiwavelength optical signal, comprising the steps of:

(i) receiving the multiwavelength optical signal,
(ii) dispersing the multiwavelength optical signal such that different wavelength components thereof are spatially separated along a dispersion direction,
(iii) disposing at least one phase shifting element in the path of the separated wavelength components, and
(iv) actuating the at least one phase shifting element such that a phase shift having at least partially quadratic variation with distance along the dispersion direction is applied to the different wavelength components of the multiwavelength optical signal. In such a method, the at least one phase shifting element may preferably be an array of phase shifting elements.

In accordance with a further preferred embodiment of the present invention, in any of the previously described methods, the phase shift has at least a partially quadratic variation as a function of wavelength of the optical signal. In such a case, the at least partially quadratic variation of phase shift as a function of wavelength of the optical signal is preferably operative to compensate for chromatic dispersion generated in the optical signal.

In any of the above-described methods, the at least one phase shifting element is preferably actuated by means of an applied voltage.

There is even further provided in accordance with more preferred embodiments of the present invention, a method such as those described above, and wherein at least one of the phase shifting elements is a liquid crystal element.

Furthermore, any of the methods described above preferably also comprises the step of varying the phase shift dynamically, such that the chromatic dispersion compensation is performed dynamically.

Additionally, in accordance with still another preferred embodiment of the present invention, in any of the above described methods using an array of phase shifting elements, when the multiwavelength optical signal comprises a number of channels equally spaced in frequency from each other, the array of phase shifting elements may preferably be disposed such that successive channels of the multiwavelength optical signal fall on successive elements of the array. Alternatively and preferably, the array of phase shifting elements may be disposed such that at least one of the channels of the multiwavelength optical signal falls on successive elements of the array.

### BRIEF DESCRIPTION OF THE DRAWINGS

The present invention will be understood and appreciated more fully from the following detailed description, taken in conjunction with the drawings in which:

FIG. 1 schematically illustrates a dispersion compensation device based on free-space optics, using gratings, lenses and a phase shifting array, constructed and operative according to a first preferred embodiment of the present invention;

FIGS. 2A to 2D schematically illustrate methods by which the phase can be controlled to induce quadratic dependence with frequency in the device of FIG. 1, using phase-changing pixelated elements; FIGS. 2A and 2B illustrate multi-pixel embodiments; FIG. 2C is a schematic graph of the frequency dependence of the phase shift generated in the embodiments of FIGS. 2A and 2B for two different quadratic phase shift characteristics; FIG. 2D illustrates schematically a simple form of a phase control arrangement, according to a further preferred embodiment of the present invention, using only one phase shifting element per channel;

FIG. 3 illustrates a schematic side view of the preferred embodiment of FIG. 2D;

FIGS. 4A to 4D illustrate graphically the calculated dispersion as a function of frequency for the preferred device of FIG. 3;

FIGS. 5A and 5B illustrate graphically the maximal dispersion values and the associated power penalty as a function of the applied phase, for the simulations shown in FIGS. 4A to 4D; and

FIGS. 6A to 6C which show simulated examples of Eye-diagrams illustrating the improvement in chromatic dispersion achievable using a device constructed and operative according to the present invention.

### DETAILED DESCRIPTION OF PREFERRED EMBODIMENTS

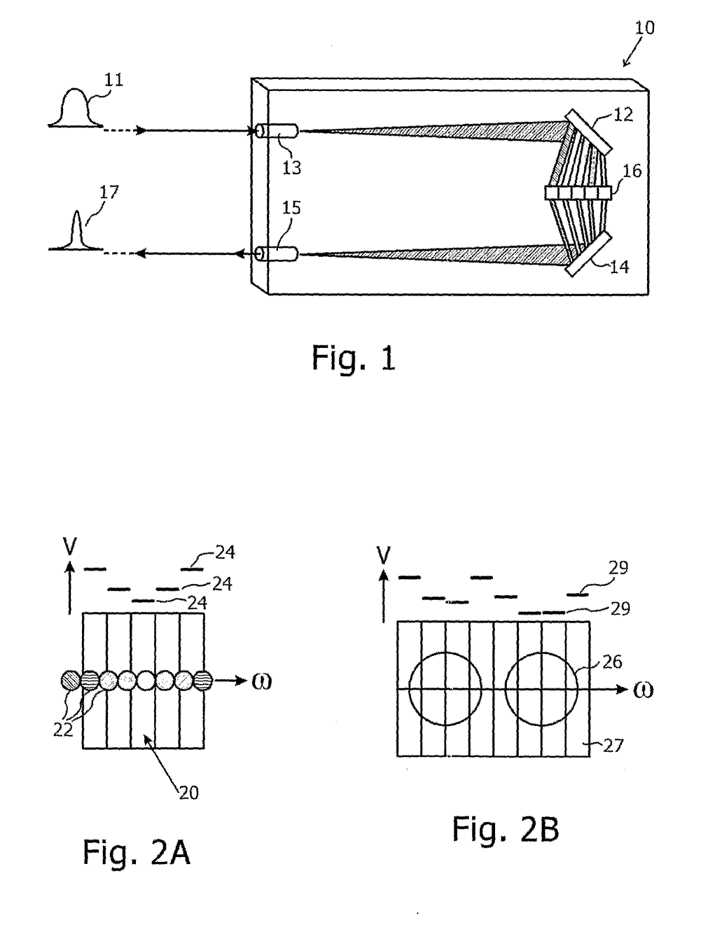

Reference is now made to FIG. 1, which illustrates schematically a dispersion compensation device 10 constructed and operative according to a first preferred embodiment of the present invention. The device utilizes free-space optics, wavelength dispersion components such as gratings to channelize the input multiwavelength signals, and a phase shifting array made up of individual phase shifter elements to implement the dispersion correction for each channel. Although the specific details of the device may vary, in general, the operation is based on the dispersion in space of the wavelengths of the chromatically dispersed optical signals of the transmission 11, by means of a dispersive device 12, so that different DWDM channels are spatially separated. The phases of each channel can then be controlled separately in a manner that will induce a quadratically varying phase change to the wavelengths of the channel. The form of this quadratic phase change is preferably set independently for each of the channels. The quadratic phase change can preferably be induced by the use of an array of phase modulating elements 16, such as an array of liquid crystal pixels, each pixel generally applying a different phase shift from that of its neighboring pixels, by the application of a different bias voltage to the electrodes of the pixel. Once the appropriate phase change required to provide dispersion correction has been applied to each channel, the signals from all of the channels are spatially recombined in a second dispersive component 14, and are output from the device 10 as a multi-wavelength signal with greatly reduced chromatic dispersion 17. Since the phase shift generated in each of the phase shifting elements of the array 16 can be varied by application of the appropriate drive voltage to each element, the dispersion compensation can be changed dynamically during transmission, in order to take into account differing transmission conditions, or different routing configurations within the system.

The polarization of the optical signal passing through the dispersion compensation device 10 should be defined, so that each operative optical component of the device will function predictably. This can preferably be performed by any of the methods known in the art, such as the use of walk-off crystals or C-polarizers 13, 15, at the input and output of the device. Furthermore, it is understood that the device may also include any other optical components necessary for the directing of the optical beams within the device, such as focusing lenses or collimating lenses or beam benders, as are known in the art, but which are omitted from FIG. 1 for clarity.

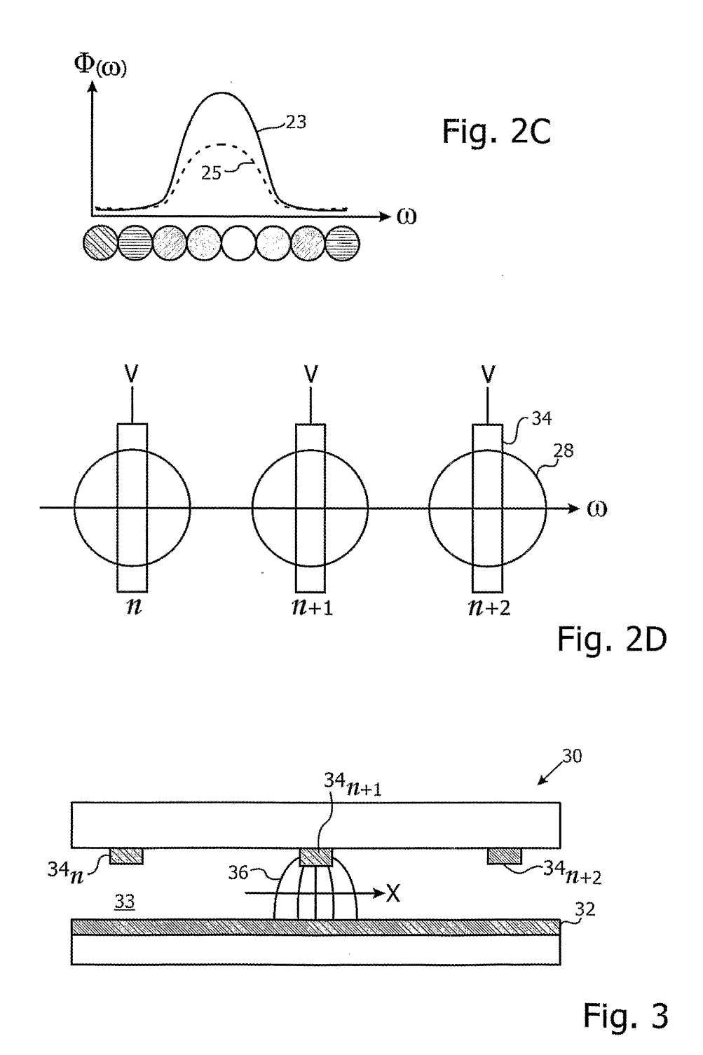

Reference is now made to FIG. 2A, which schematically illustrates a first preferred method by which the phase can be controlled to induce quadratic dependence with frequency. In FIG. 2A there is shown an array of phase-changing pixelated elements 20, which may preferably be liquid crystal elements, arranged so that as the incident optical signal is dispersed onto these pixels, different frequency components 22 experience different phase shifts. The quadratic phase shift dependence on frequency is induced by appropriately biasing the voltage 24 applied to the individual pixels, as indicated in the upper part of FIG. 2A.

Since each frequency component has a finite spot size determined by the resolution of the optical system, the actual phase-shift response can be made smoother than the digitized voltage function applied to the individual pixilated electrodes of the phase shifting device, by making the pixels sufficiently small that the illuminating spot overlaps more than one pixel. Frequencies that are located so that they cover two pixels experience an average phase shift of the two pixels, such that it is possible to use pixels that are smaller than the system resolution (sub-pixel resolution).

Reference is now made to FIG. 2B which schematically illustrates such an embodiment, where the pixel size is chosen to be sufficiently small that the spot size covers more than one pixel. In this case, if each spot represents the frequencies within one DWDM channel 26, the phase shift over each channel is then controlled by a number of pixeleted electrodes 27, each with its own bias voltage 29, and each set of bias voltages adapted to the phase correction required for that channel. The use of a number of pixels per channel enables accurate compensation to be achieved for the frequencies within each channel, and although for a system with perhaps hundreds of channels, the connection and driving functions for the LC pixel electrodes may be a task of some complexity, this can be accomplished, for example by using currently available Liquid Crystal on Silicon (LCOS) technology.

Reference is now made to FIG. 2C, which is a schematic graph showing the tunability of the quadratic phase shift generator shown in FIG. 2A. By adjusting the various pixel actuating voltages V, it is possible to change the shape of the quadratic curve of the phase shifting characteristic of the device as a function of frequency, as shown in FIG. 2C by two exemplary curves 23, 25, of the frequency dependence of φ(ω) for two different selected quadratic phase shift characteristics.

The pixelated phase shifting arrays illustrated in FIGS. 2A and 2B are very effective at approximating the required quadratic phase. When liquid crystal (LC) elements are utilized for this purpose, it should be noted that although LC's generally decrease their index of refraction as a function of increasing voltage, both positive and negative dispersion can still be applied using such LC's. If the maximum voltage is applied at the center frequency, keeping both ends at lower or zero voltage, positive dispersion results; if a low or zero voltage is applied at the center, and the maximum at the ends of the array, negative dispersion is obtained.

Reference is now made to FIG. 2D which illustrates schematically a particularly simple form of a phase control arrangement, according to a further preferred embodiment of the present invention. This embodiment uses only one phase shifting element per channel, with its control voltage V applied to the single electrode 34 of the phase shifter. The pixel size is smaller than the spot waist size, as for the embodiment of FIG. 2B. The circles 28 symbolize the diffraction limited spot-size of the various channels of the dispersed input signal. The geometry of the pixel spacing relative to the dispersive power used in the device is preferably arranged such that successive DWDM channels, n, n+1, n+2, . . . fall on successive pixels, each pixel providing the quasi-quadratic phase function to approximately compensate for the chromatic dispersion within that channel.

Reference is now made to FIG. 3 which illustrates schematically, according to a further preferred embodiment of the present invention, a side view of a preferred embodiment of a single pixel per channel device 30, such as that of FIG. 2D, for inducing approximately quadratic phase shifting with a single bias electrode 34 per phase shifting pixel. The device of this embodiment preferably has a complete ground electrode 32 and each pixel of the array is preferably defined by a narrow bias electrode 34, which is smaller than the waist size of the channel spot, each pixel being labeled n, n+1, n+2, . . . corresponding to the channel number whose phase is shifted by that pixel. The region between the ground plane 32 and the pixel electrodes 34 is preferably filled with a liquid crystal material 33. As is known in the art, the electric fringing field between the narrow bias electrode 34 and the ground plane 32 drops approximately quadratically with distance, marked as the x-axis in FIG. 3, along the cell, from the position opposite the center of the narrow electrode 34. It is thus possible to induce a phase shift having an approximately quadratic function with position of the wavelength spot across the cell, thus implementing a particularly simple embodiment of the chromatic dispersion compensator of the present invention. The various physical parameters, such as the plate separation, electrode width and liquid crystal type and alignment may be used to optimize the spatial phase shift dependence.

Although the embodiment shown in FIG. 3 provides only a rough approximation to a true quadratic phase shift function, numerical stimulations show that it can provide adequate dispersion compensation for many practical applications.

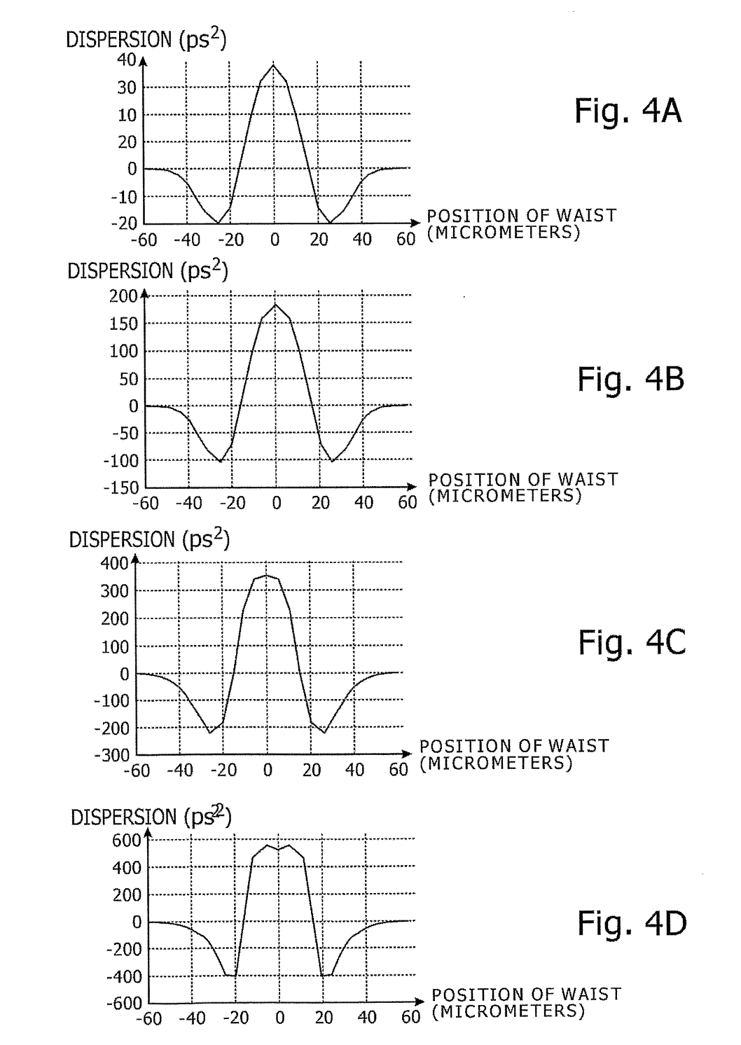

Reference is now made to FIGS. 4A to 4D which respectively illustrate graphical simulations of the value of dispersion (in ps²) as a function of frequency near the channel central frequency of a single-pixel liquid crystal dispersion compensation device, such as that shown in FIG. 2D and FIG. 3. The horizontal frequency axis is plotted in terms of the position of the waist of the spot relative to the center frequency, which is marked as zero. A distance of 100 μm along the waist position axis corresponds to a 50 GHz frequency shift. The graphs are calculated for a half 1/e² spot size of 22 micrometers, and for an electrode of 30 micrometers width. The curves are plotted for a specific element geometry and using applied voltages which induce phase shifts of 0.1, 0.5, 1 and 1.5 radians. As is observed, although the dispersion does not behave smoothly over the whole spectral width of the channel, the level of dispersion can be adjusted according to the phase shift induced as a function of the voltage applied to the pixel electrode.

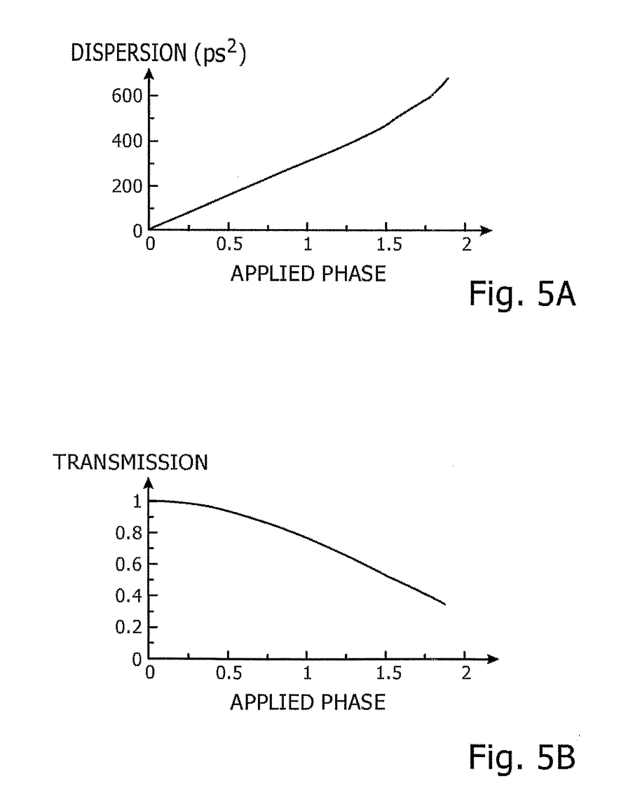

Reference is now made to FIGS. 5A and 5B, which respectively plot the maximal dispersion values for the device whose simulated results are shown in FIGS. 4A to 4D, and the associated power penalty, as a function of the applied phase, the applied phase being a function of the applied electrode voltage.

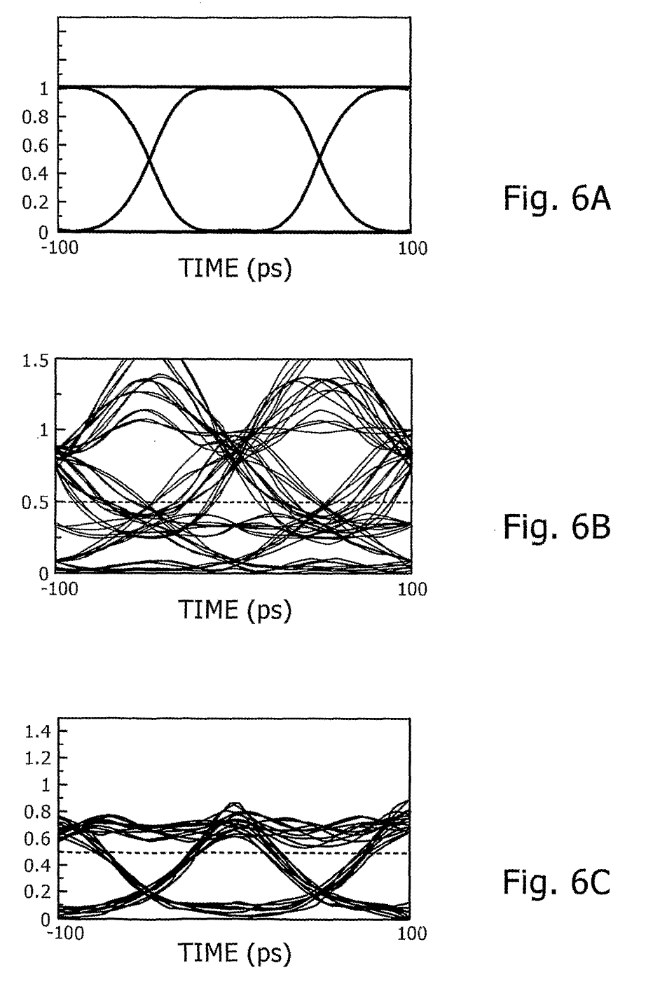

Reference is now made to FIGS. 6A to 6C which show simulated examples of eye-diagrams illustrating the improvement in chromatic dispersion achievable using a device having the parameters used in the simulations of FIGS. 4A to 4D, constructed and operative according to a preferred embodiment of the present invention. In FIG. 6A is shown the clean eye-diagram of a 10 Gb/s input transmission. FIG. 6B illustrates the effects of chromatic dispersion after transmission through 125 km. of standard fiber. FIG. 6C illustrates the improvement in the transmitted signal of FIG. 6B after dispersion compensation by passage through the above described device of the present invention.

Though the preferred embodiments shown in this application are transmissive devices, with the light entering the device through an input path, passing through the phase shifting array and exiting the device through a path separate from that of the input path, it is to be understood that the invention is not intended to be limited to such a transmissive device, but is meant to include reflective devices implemented by use of any of the methods described in the prior art. Such arrangements generally include the positioning of a reflective surface immediately after the phase shifting array, such that the light passes back through the phase shifting array on its path out of the device. In such reflective devices, the phase shift generated by the individual elements need be only half of that required by the transmissive embodiments, since the light passes twice through its relevant phase shifting element. Further details of such reflective arrangements can be found, for instance, in the co-pending patent application entitled “Single pole optical wavelength selector” published as International Publication No. PCT WO 2005/052507 and in the co-pending U.S. Provisional Patent Application No. 60/671,971 entitled “Single pole optical wavelength selector”, both having co-inventors with the present application, and both herewith incorporated by reference, each in its entirety.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. An optical device comprising:
an input port for receiving a multiwavelength optical signal;
a dispersive device for spatially separating different wavelength components of said multiwavelength optical signal along a dispersion direction; and
at least one phase shifting element disposed in the path of said separated wavelength components,
wherein said at least one phase shifting element is actuated such that it applies a phase shift having at least a partially quadratic variation with distance along said dispersion direction, to said different wavelength components of said multiwavelength optical signal.

2. An optical device according to claim 1 and wherein said at least one phase shifting element is an array of phase shifting elements.

3. An optical device according to claim 1 and wherein said phase shift has at least a partially quadratic variation as a function of wavelength of said optical signal.

4. An optical device according to claim 3 and wherein said at least partially quadratic variation of phase shift as a function of wavelength of said optical signal is operative to compensate for chromatic dispersion generated in said optical signal.

5. An optical device according to claim 1 and wherein said at least one phase shifting element is actuated by means of an applied voltage.

6. An optical device according to claim 1 and wherein at least one of said phase shifting elements is a liquid crystal element.

7. An optical device according to claim 1, and wherein said at least one phase shifting element can be varied.

8. An optical device according to claim 7, and wherein said variability enables dynamic compensation of chromatic dispersion generated in an optical communication system.

9. An optical device according to claim 2, and wherein said multiwavelength optical signal comprises a number of channels equally spaced in frequency from each other, and wherein said array of phase shifting elements is disposed such that successive channels of said multiwavelength optical signal fall on successive elements of said array.

10. An optical device according to claim 2, and wherein said multiwavelength optical signal comprises a number of channels equally spaced in frequency from each other, and wherein said array of phase shifting elements is disposed such that at least one of said channels of said multiwavelength optical signal falls on successive elements of said array.

11. A method of compensating for chromatic dispersion in a multiwavelength optical signal, comprising the steps of:
receiving said multiwavelength optical signal;
dispersing said multiwavelength optical signal such that different wavelength components thereof are spatially separated along a dispersion direction;
disposing at least one phase shifting element in the path of said separated wavelength components; and
actuating said at least one phase shifting element such that a phase shift having at least partially quadratic variation with distance along said dispersion direction is applied to said different wavelength components of said multiwavelength optical signal.

12. A method according to claim 11 and wherein said at least one phase shifting element is an array of phase shifting elements.

13. A method according to claim 11 and wherein said phase shift has at least a partially quadratic variation as a function of wavelength of said optical signal.

14. A method according to claim 13 and wherein said at least partially quadratic variation of phase shift as a function of wavelength of said input optical signal is operative to compensate for chromatic dispersion generated in an optical signal.

15. A method according to claim 11 and wherein said step of actuating is performed by using an applied voltage.

16. A method according to claim 11 and wherein at least one of said phase shifting elements is a liquid crystal element.

17. A method according to claim 11 and also comprising the step of varying said phase shift dynamically, such that said chromatic dispersion compensation is performed dynamically.

18. A method according to claim 12, and wherein said multiwavelength optical signal comprises a number of channels equally spaced in frequency from each other, and wherein said array of phase shifting elements is disposed such that successive channels of said multiwavelength optical signal fall on successive elements of said array.

19. A method according to claim 12, and wherein said multiwavelength optical signal comprises a number of channels equally spaced in frequency from each other, and wherein said array of phase shifting elements is disposed such that at least one of said channels of said multiwavelength optical signal falls on successive elements of said array.
